(19) United States
(12) Patent Application Publication
(10) Pub. No.: US 2007/0133075 A1
(43) Pub. Date: Jun. 14, 2007

(54) Holographic recording medium

(75) Inventors: Hiroshi Sakamoto, Ibaraki-shi (JP); Tatsuya Imazu, Ibaraki-shi (JP)

Correspondence Address: OLIFF & BERRIDGE, PLC, P.O. BOX 19928, ALEXANDRIA, VA, 22320, US

(73) Assignee: HITACHI MAXELL, LTD., IBARAKI-SHI (JP)

(21) Appl. No.: 11/635,606

(22) Filed: Dec. 8, 2006

(30) Foreign Application Priority Data
Dec. 9, 2005 (JP) 2005-355963

(51) Int. Cl. G03H 1/00

(52) U.S. Cl. 359/1

(57) ABSTRACT

A holographic recording medium is provided, which has a first substrate which has a recess on a surface; an information-recording layer which is formed in the recess of the first substrate; and a second substrate which is formed on the information-recording layer; wherein an area of a surface of the second substrate is smaller than an area of an opening which is defined on the surface of the first substrate by the recess of the first substrate. The reliable holographic recording medium makes it possible to correctly record and reconstruct the stored information even when the holographic recording medium is used in an environment in which the temperature is changeable.

### BACKGROUND OF THE INVENTION

1. Field of the Invention

The present invention relates to a holographic recording medium.

2. Description of the Related Art

In association with the advance of the high-definition television and the digital terrestrial broadcasting in the television broadcasting, it is required to provide a recording medium or data storage medium having a high storage capacity as an archive recording medium. A variety of recording media have been suggested in order to respond to such a request. In recent years, the attention is especially directed to the holographic recording medium which has the features of the high recording capacity, the high transfer rate, and the capability of random access.

In general, the holographic recording medium includes an information-recording layer or holographic-recording layer and substrates which are provided on both surfaces of the information-recording layer. The information-recording layer is held or retained by being sandwiched between the two substrates as shown, for example, Japanese Patent Application Laid-open No 2005-17589. In the case of the holographic recording medium, unlike the traditional optical disk, two light beams as recording (or signal) beam and reference beam are radiated onto the information-recording layer to form an interference pattern of the recording beam and the reference beam in the thickness direction of the information-recording layer, thereby recording the information. The interference pattern can be changed, for example, by changing the angle between the recording beam and the reference beam (angle multiplexing). Therefore, it is possible to superimpose different interference patterns in a same location, thereby achieving the high density recording. In the reading process, the reference light beam is radiated onto the holographic recording medium while changing the angle of the reference light beam. Then, the interference pattern (recorded information), which corresponds to the angle of the reference light beam, is detected, and the information is reproduced or reconstructed. The material as the substrate is usually used optical disk grade thermoplastic resin or glass. Further, a base member is also known other than the transparent substrate, in which a reflective layer or an anti-reflective layer is provided on one surface of the transparent substrate.

These days, a polymer resin is mainly used as a base component for the information-recording layer of the holographic recording medium. However, such a material tends to be affected by the external environment. For example, when the information-recording layer is exposed to the moisture in the atmosphere, the polymer resin is deteriorated. In order to solve this problem of the moisture absorption of the polymer resin, a method has been suggested, in which an opening of an information-recording layer is sealed as shown, for example, Published Japanese Translation of PCT International for Patent Application No. 2004-524583. FIG. 1 shows a schematic cross-sectional view illustrating a holographic recording medium suggested in Published Japanese Translation of PCT International for Patent Application No. 2004-524583. As shown in FIG. 1, the holographic recording medium disclosed in Published Japanese Translation of PCT International for Patent Application No. 2004-524583 includes an information-recording layer 13, substrates 11, 12 which are provided on upper and lower surfaces of the information-recording layer 13, and a sealing member 14 which seals side portions (opening) of the information-recording layer 13.

On the other band, another holographic recording medium using the sealing film has been suggested. This sealing film is formed of a polymeric film having a thickness of not more than 100 μm in order to provide the holographic recording medium which is excellent in the heat resistance (see, for example, Japanese Patent Application Laid-open No. 2000-9938).

### SUMMARY OF THE INVENTION

As described above, the holographic recording medium (holographic data storage medium) tends to undergo the influence of the change of the external environment. In the case that a coefficient of thermal expansion (CTE) of the information-recording layer (holographic-recording layer) is greatly larger than the CTE of the substrate and the sealing member (sealing film), the stress and/or distortion (stress strain) appears in the information-recording layer due to the difference in CTE, when the temperature change is large. For example, when the structure is adopted, in which all of the surfaces of the information-recording layer 13 are entirely surrounded by the substrates 11, 12 and the seal member 14 as shown in FIG. 1, the thermal expansion or the thermal contraction of the information-recording layer 13 is suppressed by the substrates 11, 12 and the seal member 14. Therefore, the stress or distortion of the information-recording layer 13, may be increased. When the stress or distortion arises in the information-recording layer, the recorded hologram (interference pattern) also has the stress or distortion change (the change also arises in the recorded information image). As a result, information could not be reproduced (reconstructed) correctly, and the reading error is increased. At present, any effective solution has not been suggested for this problem.

The present invention has been made in order to solve the problem as described above. An object of the present invention is to provide a reliable holographic recording medium which makes it possible to correctly record and reproduce information even when the holographic recording medium is used in a changeable environment, for example, the environment in which the change of the external environment, especially the temperature change arises.

According to an aspect of the present invention, there is provided a holographic recording medium comprising a first substrate which has a recess on a surface thereof; an information-recording layer which is formed in the recess of the first substrate; and a second substrate which has a surface and is formed on the information-recording layer; wherein an area of the surface of the second substrate is smaller than an area of an opening which is defined on the surface of the first substrate by the recess of the first substrate.

In the holographic recording medium (the holographic data storage medium) of the present invention, the information-recording layer (holographic-recording layer) is formed in the recess of the first substrate and is surrounded by the side wall of the recess of the first substrate. Therefore, when the temperature change arises in the external environment, the thermal expansion or the thermal contraction of the information-recording layer in the layer direction is suppressed by the side walls of the recess of the first substrate. As a result, the information-recording layer undergoes the thermal expansion or the thermal contraction only in the thickness direction thereof. Also, the area or a real size of the surface of the second substrate is smaller than the area or a real size of the opening defined on the surface of the first substrate by the recess of the first substrate. Therefore, the information-recording layer can expand or contract freely in the thickness direction without the friction resistance between the first and second substrates, even when the temperature change occurs in the external environment. In this situation, the surface of the information-recording layer is moved in the thickness direction of the information-recording layer together with the second substrate while maintaining the parallelism of the surface of the information-recording layer by the second substrate, because the second substrate is provided on the information-recording layer. As a result, in the holographic recording medium of the present invention, the information-recording layer is not warped (the stress does not arise in the information-recording layer), even when the temperature change arises in the environment of use. Therefore, in the case of the holographic recording medium of the present invention, the information (data) can be correctly recorded and reproduced or reconstructed even when the temperature change arises in the environment of use.

In the holographic recording medium of the present invention, the first substrate and the second substrate may make no contact with each other. In this case, it is possible to more smoothly effect the movement (thermal expansion or thermal contraction) of the surface of the information-recording layer in the thickness direction when the temperature of the environment is changed.

In the holographic recording medium of the present invention, the gap is defined between the first substrate and the second substrate, because the area of the surface of the second substrate is smaller than the area of the opening defined on the surface of the first substrate by the recess of the first substrate. The width of the gap can be appropriately set depending on the materials of the substrate and the information-recording layer. However, it is preferable to provide such a width that the first substrate and the second substrate make no contact with each other even when the temperature change arises, considering, for example, the influence of the thermal expansion or the thermal contraction of the first substrate, the second substrate, and the information-recording layer when the temperature change arises. For example, when the substrate is formed of a transparent thermoplastic resin for the optical disk grade thermoplastic resin, and the information-recording layer is formed of a photopolymer, then it is preferable that the width of the gap is about 0.5 to 1.0 mm.

In the holographic recording medium of the present invention, the area or a real size of the surface of the second substrate may have an area or a real size which covers at least a recording area of the information-recording layer.

In the holographic recording medium of the present invention, the holographic recording medium may further comprise a sealing film which covers at least a gap between the first substrate and the second substrate. When the consideration is made, for example, about the mass productivity of the holographic recording medium, the sealing film may cover the second substrate and the gap between the first substrate and the second substrate.

When the sealing film is provided to cover the gap between the first substrate and the second substrate, the information-recording layer can be reliably blocked or shielded from the atmospheric air. Therefore, the problem of the moisture absorption as described above is not caused. Further, because the sealing film is a film-shaped member, the movement of the surface of the information-recording layer in the thickness direction is not inhibited when the temperature is changed. The sealing film has some resistance for extension in the thickness direction of the information-recording layer. Therefore, the sealing film is not broken, even when the surface of the information-recording layer is moved in the thickness direction during the temperature change. That is, when the gap between the first substrate and the second substrate is covered with the sealing film, the information-recording layer can be blocked or shielded from the atmospheric air without inhibiting the movement of the surface of the information-recording layer in the thickness direction during the temperature change.

In the holographic recording medium of the present invention, the holographic recording medium may further comprise a stress-absorbing layer which is disposed between the information-recording layer and a side wall for defining the recess of the first substrate. When the holographic recording medium has the structure as described above, the stress, which is arisen in the layer direction of the information-recording layer, is mitigated and absorbed by the stress-absorbing layer. Therefore, it is possible to further suppress the stress or stress stain caused by the difference in the coefficient of thermal expansion between the information-recording layer and the first substrate.

In the holographic recording medium of the present invention, a side wall for defining the recess of the first substrate and the information-recording layer may make no contact with each other the phrase “make no contact” referred to herein means the state that the side wall for defining the recess of the first substrate and the information-recording layer make no contact with each other, both directly and indirectly. Therefore, the phrase does not include any indirect contact between the side wall for defining the recess of the first substrate and the information-recording layer via the stress-absorbing layer as described above. When the holographic recording medium has the structure as described above, the information-recording layer is free or released in the layer direction as well. Therefore, it is possible to almost completely eliminate the stress caused by the difference in the coefficient of thermal expansion between the information-recording layer and the first substrate.

In the holographic recording medium of the present invention, a base material for the information-recording layer may be a polymer resin.

According to the holographic recording medium of the present invention, the information-recording layer is formed in the recess of the first substrate, and the second substrate, which has the area smaller than the area of the opening defined on the surface of the first substrate by the recess of the first substrate, is formed on the information-recording layer. As a result, the information-recording layer is free in the thickness direction, that is, the surface of the information-recording layer is freely movable in the thickness direction thereof. Therefore, even when the information-recording layer is thermally expanded or thermally contracted depending on the temperature change in the external environment, it is possible to suppress the stress in the information-recording layer.

In the holographic recording medium of the present invention, the second substrate is provided on the information-recording layer. Therefore, even when the temperature change arises in the external environment, the information-recording layer is expanded or contracted in the state in which the parallelism of the surface of the information-recording layer is maintained without warping the information-recording layer in the thickness direction thereof. Therefore, in the case of the holographic recording medium of the present invention, the information can be recorded and reproduced or reconstructed correctly even when the temperature change arises in the external environment. It is possible to provide the reliable holographic recording medium.

### BRIEF DESCRIPTION OF THE DRAWINGS

FIG. 1 shows a schematic cross-sectional view illustrating a traditional holographic recording medium.

FIGS. 2A and 2B show a schematic arrangement of a holographic recording medium of a first embodiment, wherein FIG. 2A shows a perspective view, and FIG. 2B shows a sectional view taken along a line IIB-IIB shown in FIG. 2A.

FIGS. 3A and 3B show a schematic arrangement of a holographic recording medium of a second embodiment, wherein FIG. 3A shows a perspective view, and FIG. 3B shows a sectional view taken along a line IIIB-IIIB shown in FIG. 3A.

FIG. 4 shows a schematic sectional view illustrating a holographic recording medium of a first modified embodiment.

FIG. 5 shows a schematic sectional view illustrating a holographic recording medium of a second modified embodiment.

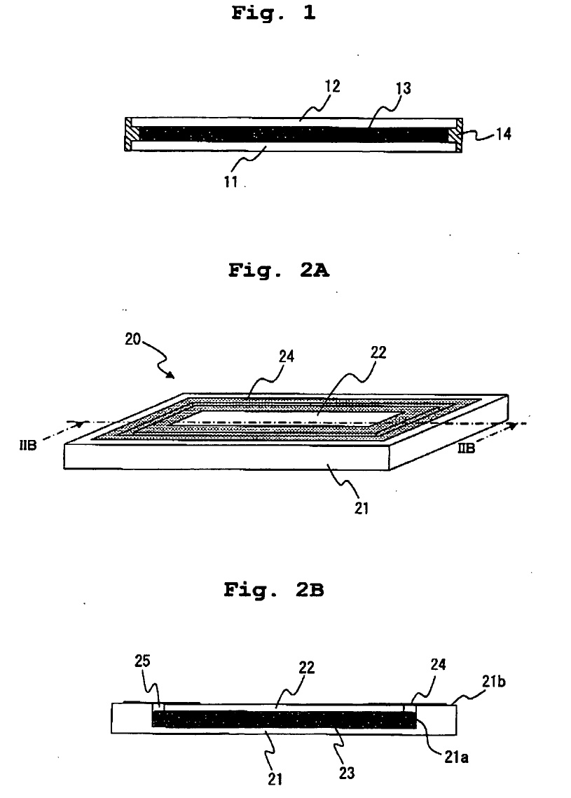

### DESCRIPTION OF THE PREFERRED EMBODIMENTS

Embodiments of the holographic recording medium (holographic data storage medium) of the present invention will be specifically explained below with reference to the drawings. However, the present invention is not limited thereto.

### First Embodiment

FIGS. 2A and 2B show a schematic arrangement of a holographic recording medium of a first embodiment. FIG. 2A shows a perspective view illustrating the holographic recording medium, and FIG. 2B shows a sectional view taken along a line IIB-IIB shown in FIG. 2A. As shown in FIGS. 2A and 2B, the holographic recording medium 20 of this embodiment includes a base substrate 21 (first substrate) which has a recess 21a formed on a surface thereof, a holographic recording layer 23 (information-recording layer) which is formed in the recess 21a of the base substrate 21, a lid substrate 22 (second substrate) which is formed on the holographic recording layer 23, and a sealing film 24. As shown in FIG. 2B, the holographic recording medium 20 of this embodiment is formed so that the position of the upper surface 21b of the base substrate 21 is flush with the upper surface of the lid substrate 22. In the case of the holographic recording medium of this embodiment, as necessary, a reflective film or reflective layer may be formed on the base substrate 21 or the lid substrate 22, or an anti-reflective film or anti-reflective layer may be formed on both of the base substrate 21 and the lid substrate 22. The positions, at which the reflective film and the anti-reflective film are formed, are arbitrary, which may be appropriately changed depending on application and the like. The reflective film and the anti-reflective film may be formed over the entire surface of the substrate, or they may be formed partially.

As shown in FIGS. 2A and 2B, the base substrate 21 is a quadrilateral or rectangular plate-shaped member. The base substrate 21 was formed of an amorphous olefinic resin which is one of thermoplastic resins for the optical disk. The dimension of the base substrate 21 was 50 mm×40 mm×3.5 mm. The recess 21a was formed at the central portion of the surface of the base substrate 21. In this embodiment, the opening, which was defined on the surface of the base substrate 21 by the recess 21a, was quadrilateral or rectangular, and the dimension thereof was 34 mm×24 mm. The depth of the recess 21a was 2.5 mm.

The holographic recording layer 23 was formed of a photosensitive polymer, and a thickness of the holographic recording layer 23 was 1.5 mm. In this embodiment, the area, which did not include an area ranging from the outer edge of the holographic recording layer 23 to a position located inside the outer edge by 5 mm, was used as the recordable area of the holographic recording layer 23.

The lid substrate 22 is a quadrilateral or rectangular plate-shaped member. The lid substrate 22 was formed of an amorphous olefinic resin which is one of thermoplastic resins for the optical disk in the same manner as the base substrate 21. The dimension of the lid substrate 22 was 32 mm×22 mm×1 mm. That is, the area of the surface of the lid substrate 22 was smaller than the area of the opening defined on the surface of the base substrate 21 by the recess 21a of the base substrate 21. Therefore, in the case of the holographic recording medium 20 of this embodiment, as shown in FIGS. 2A and 2B, a gap 25 is formed between the side surface of the lid substrate 22 and the side wall for defining the recess 21a of the base substrate 21. The base substrate 21 and the lid substrate 22 are in a non-contact state. In this embodiment, the lid substrate 22 was attached so that the lid substrate 22 covered the recording area of the holographic recording layer 23.

The sealing film 24 was formed by using a material in which a base material was a thin plastic film, which is specifically a polyethylene film vapor-deposited with aluminum. In this embodiment, as shown in FIG. 2A, the sealing film 24, which had an opening at a central portion thereof, was used. The sealing film 24 was attached to the base substrate 21 and the lid substrate 22 to seal the gap 25 so that the area, which ranged from the area disposed in the vicinity of the outer end of the upper surface of the lid substrate 22 to the upper surface 21b of the base substrate 21, was covered with the sealing film 24.

The holographic recording medium 20 of this embodiment was manufactured as follows. At first, the base substrate 21, which had the recess 21a formed on the surface thereof, was manufactured by means of the injection molding method. Subsequently, the photosensitive polymer was poured into the recess 21a of the base substrate 21. Subsequently, the lid substrate 22 was placed on the resin in the recess 21a, and the resin was cured in this state to form the holographic recording layer 23. The lid substrate 22 was retained by a suction plate so that the parallelism was maintained between the base substrate 21 and the lid substrate 22 during the curing of the resin. Subsequently, the sealing film 24 was attached to the lid substrate 22 and the base substrate 21 so as to cover the gap 25 defined between the lid substrate 22 and the recess 21a of the base substrate 21. In this embodiment, the sealing film 24 was attached to the base substrate 21 and the lid substrate 22 as follows. At first, the sealing film 24 was placed on the base substrate 21 and the lid substrate 22 so that the surface of the sealing film 24, which was disposed on the side of the polyethylene film, was opposed to the lid substrate 22. Subsequently, the sealing film 24 was heated to melt the polyethylene film. Thus, the sealing film 24 was attached to the base substrate 21 and the lid substrate 22. The holographic recording medium 20 of this embodiment was manufactured in accordance with the method as described above.

In the holographic recording medium 20 of this embodiment, as described above, the holographic recording layer 23 is formed in the recess 21a of the base substrate 21, and the lid substrate 22, which has the dimension smaller than the dimension of the opening defined on the surface of the base substrate 21 by the recess 21a of the base substrate 21, is provided on the holographic recording layer 23. Therefore, the holographic recording layer 23 is in the released state on the side of the lid substrate 22. Therefore, even when the temperature change arises in the external environment, and the holographic recording layer 23 is thermally expanded or thermally contracted, then the surface of the holographic recording layer 23 is freely moved in the thickness direction thereof. Therefore, no stress arises in the holographic recording layer 23 of the holographic recording medium 20 of this embodiment.

When the holographic recording medium 20 is thermally expanded or thermally contracted, the surface of the holographic recording layer 23 is moved in the thickness direction thereof together with the lid substrate 22 while maintaining the parallelism of the surface of the holographic recording layer 23, because the lid substrate 22 is provided on the holographic recording layer 23. Therefore, in the case of the holographic recording medium of this embodiment, the information can be easily reproduced or reconstructed by changing the wavelength of the reference beam (reproducing beam) depending on the amount of thermal expansion or the amount of thermal contraction (amount of temperature change) of the holographic recording layer 23. Therefore, in the case of the holographic recording medium 20 of this embodiment, the information can be correctly recorded and reconstructed, even when the temperature change occurs in the external environment.

The sealing film 24, which is provided on the upper surface of the holographic recording medium 20 of this embodiment, uses the thin plastic film as the base material. Therefore, the sealing film 24 is strong against the bending in the thickness direction of the holographic recording layer 23. Even when the holographic recording layer 23 is thermally expanded or thermally contracted, and the lid substrate 22 is moved in the thickness direction thereof, then the sealing film 24 can endure the movement, and the sealing film 24 is not broken. Therefore, in the case of the holographic recording medium of this embodiment, the sealing effect is maintained, even when the temperature change arises in the external environment, and the holographic recording layer 23 is thermally expanded or thermally contracted in the thickness direction thereof.

### Second Embodiment

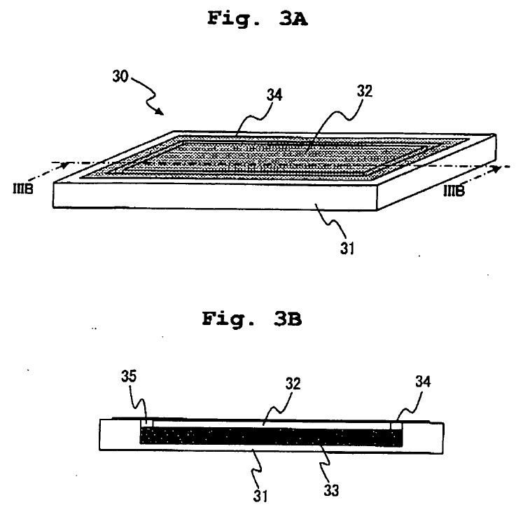

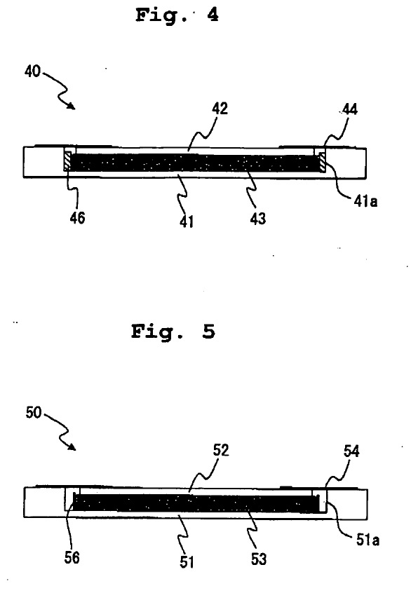

FIGS. 3A and 3B show a schematic arrangement of a holographic recording medium of a second embodiment FIG. 3A shows a perspective view illustrating the holographic recording medium, and FIG. 3B shows a sectional view taken along a line IIIB-IIIB shown in FIG. 3A. The structure of the holographic recording medium of this embodiment was the same as that of the first embodiment except that a film-shaped seal member, which was not formed with any opening at the central portion thereof, was used as a sealing film 34 as shown in FIGS. 3A and 3B. Therefore, also in the holographic recording medium of this embodiment, the stress of the holographic recording layer 33, which would be otherwise caused by the temperature change in the external environment, can be suppressed with the same principle as that of the first embodiment. Therefore, it is possible to obtain the effect which is the same as or equivalent to that of the first embodiment.

### First Modified Embodiment

FIG. 4 shows a schematic sectional view illustrating a holographic recording medium of a first modified embodiment. The structure of the holographic recording medium of this embodiment was the same as that of the first embodiment except that the holographic recording medium 40 had a stress-absorbing layer 46 which was provided between side walls for defining a recess 41a of a base substrate 41 and side surfaces of a holographic recording layer 43 as shown in FIG. 4.

When the temperature change arises, the holographic recording layer 43 is thermally expanded or thermally contracted not only in the thickness direction thereof but also in the layer direction thereof. The stress-absorbing layer 46 is the layer provided to absorb the stress added in the layer direction of the holographic recording layer caused by the thermal expansion or the thermal contraction of the holographic recording layer 43 in the layer direction. When the stress-absorbing layer 46 is provided between the side wall for defining the recess 41a of the base substrate 41 and the side surface of the holographic recording layer 43 as in this embodiment, the stress, which is added in the layer direction of the holographic recording layer 43, is mitigated. Therefore, it is possible to decrease the amount of expansion of the holographic recording layer 43 in the thickness direction as well, as compared with the holographic recording media of the first and second embodiments. Therefore, in the case of the holographic recording medium 40 of this embodiment, it is impossible to further suppress the stress of the holographic recording layer 43, and it is possible to record and reconstruct the information more correctly, even when the temperature change arises in the external environment.

Any arbitrary material may be used as the material for forming the stress-absorbing layer 46 provided that the material absorbs the stress. It is especially preferable that the stress-absorbing layer 46 is formed of a porous material. Specifically, those usable may include porous materials such as soft urethane sponges and polystyrene products formed by the foaming with foaming agents such as butane.

The holographic recording medium 40 of this embodiment can be manufactured, for example, as follows. At first, the base substrate 41, which has the recess 41a formed on the surface thereof, is manufactured by means of the injection molding method in the same manner as the first embodiment. Subsequently, the foamed polystyrene having a thickness of about 1 mm is stuck along the inner wall of the recess 41a, to form the stress-absorbing layer 46. Subsequently, the photosensitive polymer is poured into the area surrounded by the stress-absorbing layer 46. Subsequently, the lid substrate 42 is attached in the same manner as in the first embodiment, and then the photosensitive polymer is cured to form the holographic recording layer 43. Further, the sealing film 44 is attached in the same manner as in the first embodiment. Thus, the holographic recording medium 40 of this embodiment can be manufactured.

### Second Modified Embodiment

FIG. 5 shows a schematic sectional view illustrating a holographic recording medium of a second modified embodiment. The structure of the holographic recording medium of this embodiment was the same as that of the first embodiment except that the holographic recording medium 50 had such a structure that a frame 56 having a thin thickness was provided on side surfaces of the holographic recording layer 43, and no contact was made between the frame 56 and side walls for defining a recess 51a of a base substrate 51 as shown in FIG. 5. That is, in this structure, completely no contact was made between the side wall for defining the recess 51a of the base substrate 51 and the side surface of the holographic recording layer 53.

When the frame 56 having the thin thickness is provided on the side surface of the holographic recording layer 53, and the frame 56 does not make contact with the side wall for defining the recess 51a of the base substrate 51 as in this embodiment, then the stress, which is added in the layer direction of the holographic recording layer 53, is mitigated in the same manner as in the first modified embodiment. Therefore, it is possible to decrease the amount of expansion of the holographic recording layer in the thickness direction thereof as well, as compared with the holographic recording media of the first and second embodiments. Therefore, in the case of the holographic recording medium 50 of this embodiment, it is possible to further suppress the stress of the holographic recording layer 53, and it is possible to record and reproduce the information more correctly, even when the temperature change arises in the external environment.

Any material may be used as the material for forming the frame 56 provided that the material can be used for the side wall of the holographic recording layer 53. For example, it is possible to use thin corrugated cardboards and thick paper sheets.

The holographic recording medium 50 of this embodiment can be manufactured, for example, as follows. At first, the base substrate 51 is manufactured in the same manner as in the first embodiment. Subsequently, a spacer having a predetermined thickness is arranged along the inner wall of the recess 51a. In this situation, the spacer is not adhered to the inner wall of the recess 51a. The spacer is finally detached from the holographic recording medium as described later on. Therefore, any arbitrary material may be used as the spacer. A porous material may be used as in the stress-absorbing layer 46 of the first modified embodiment. Alternatively, any material other than the above may be used. Subsequently, the frame having the thin thickness is allowed to extend along the inner wall of the spacer to form the frame 56. In this situation, the frame 56 is not adhered to the spacer. Subsequently, the photosensitive polymer is poured into the area surrounded by the frame 56. The lid substrate 52 is attached in the same manner as in the first embodiment, and then the photosensitive polymer is cured to form the holographic recording layer 53. Subsequently, the spacer is removed. After that, the sealing film 54 is attached in the same manner as in the first embodiment. Thus, the holographic recording medium 50 of this embodiment can be manufactured.

In the first and second embodiments, the quadrilateral or rectangular holographic recording medium has been explained by way of example. However, the present invention is not limited thereto. The shape of the holographic recording medium can be appropriately changed depending on the application. For example, it is also allowable to adopt circular, elliptical, and polygonal shapes In the first and second embodiments, the quadrilateral or rectangular opening, which is formed on the surface of the base substrate, has been explained by way of example. However, the present invention is not limited thereto. The shape of the opening can be appropriately changed depending on the application. For example, it is also allowable to adopt circular, elliptical, and polygonal shapes.

In the first and second embodiments, the quadrilateral or rectangular lid substrate has been explained by way of example. However, the present invention is not limited thereto. The lid substrate can be formed to have any arbitrary shape provided that the lid substrate has the shape and the size to cover the recording area of the holographic recording layer. For example, it is also allowable to adopt circular, elliptical, and polygonal shapes.

In the first and second embodiments, the exemplary arrangement has been explained, wherein the angle between the bottom surface and the side walls for defining the recess of the base substrate, is about 90°. However, the present invention is not limited thereto. The side wall for defining the recess of the base substrate may have a tapered shape. Alternatively, for example, it is also allowable to adopt such a structure that minute holes or the like are provided on the surface of the side wall for defining the recess of the base substrate to mitigate the stress in the layer direction of the holographic recording layer by the side wall.

In the holographic recording medium of the present invention, the stress does not appear in the information-recording layer, even when the temperature change arises in the external environment. It is possible to correctly record and reconstruct (reproduce) the information. Therefore, the holographic recording medium of the present invention is preferred as the recording medium having the high storage capacity capable of being used in every environment.

What is claimed is:

1. A holographic recording medium comprising:
a first substrate which has a recess on a surface thereof;
an information-recording layer which is formed in the recess of the first substrate; and
a second substrate which has a surface and is formed on the information-recording layer, wherein:
an area of the surface of the second substrate is smaller than an area of an opening which is defined on the surface of the first substrate by the recess of the first substrate.

2. The holographic recording medium according to claim 1, wherein the first substrate and the second substrate make no contact with each other.

3. The holographic recording medium according to claim 1, wherein the area of the surface of the second substrate has an area which covers at least a recording area of the information-recording layer.

4. The holographic recording medium according to claim 1, further comprising a sealing film which covers at least a gap between the first substrate and the second substrate.

5. The holographic recording medium according to claim 4, wherein the sealing film covers the second substrate and the gap between the first substrate and the second substrate.

6. The holographic recording medium according to claim 1, further comprising a stress-absorbing layer which is disposed between the information-recording layer and a side wall for defining the recess of the first substrate.

7. The holographic recording medium according to claim 1, wherein a side wall for defining the recess of the first substrate and the information-recording layer make no contact with each other.

8. The holographic recording medium according to claim 1, wherein a base material for the information-recording layer is a polymer resin.
